(19) United States
(12) Patent Application Publication
(10) Pub. No.: US 2005/0159498 A1
(43) Pub. Date: Jul. 21, 2005

(54) Flame retardant composition and polyurethane foam containing same

(76) Inventors: Larry L. Bradford, Lufkin, TX (US); Danielle Bright, New City, NY (US); Emanuel Pinzoni, Hawthorne, NJ (US)

Correspondence Address: DILWORTH & BARRESE, LLP, 333 EARLE OVINGTON BLVD., UNIONDALE, NY, 11553, US

(21) Appl. No.: 11/019,892

(22) Filed: Dec. 21, 2004

Related U.S. Application Data
(63) Continuation-in-part of application No. PCT/US04/27788, filed on Aug. 26, 2004.
(60) Provisional application No. 60/498,798, filed on Aug. 29, 2003.

(51) Int. Cl. C08K 3/00; C08J 9/00

(52) U.S. Cl. 521/107; 252/601

(57) ABSTRACT

A flame retardant composition especially useful for imparting flame retardancy to polyurethane foams includes:
a) major amount by weight of at least one phosphate ester flame retardant of the formula: 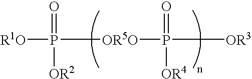
wherein n is 0 or 1 to about R¹, R², R³ and R⁴ each independently is a non-halogenated or halogenated alkyl or aryl group, and R⁵ is a non-halogenated or halogenated alkylene or arylene group, provided, that when n is 1 to about 10, at least one of R¹, R², R³, R⁴ and R⁵ is substituted with at least one halogen atom; and, b) a minor amount by weight of melamine.

### CROSS REFERENCE TO RELATED APPLICATIONS

This application is a continuation-in-part of International Application No. PCT/US2004/027788, filed Aug. 26, 2004, which claims the 35 U.S.C. § 119 (e) benefit of U.S. Provisional Application 60/498,798, filed Aug. 29, 2003. The entire contents of aforesaid applications PCT/US2004/027788 and 60/498,798 are incorporated by reference herein.

### BACKGROUND OF THE INVENTION

This invention relates to flame retardant compositions for incorporation in polyurethane foam. More particularly, the invention relates to blends of phosphate ester and melamine and the use of such blends as flame retardants for polyurethane foams.

Flexible polyurethane foams are widely used as cushioning or padding materials in furniture. Flame retardants are generally incorporated in such foams. However, it is difficult to identify a flame retardant that will achieve adequate fire retardancy economically without impacting negatively on the physical properties of polyurethane foams.

Various prior art disclosures exist in regard to the use of melamine as a flame retardant additive for polymers such as polyurethane foams. Some representative examples of such disclosures include the following:

U.S. Reissue Pat. No. 36,358 describes flame retardant polyurethane foams prepared by the reaction of a polyoxyalkylene polyether polyol with an organic polyisocyanate and a blowing agent wherein 10% to 55% of melamine is incorporated as the sole flame retardant compound.

U.S. Pat. No. 4,849,459 describes flame retardant flexible polyurethane foams prepared by reacting a polyether polyol, an organic isocyanate, a blowing agent and melamine together with an effective amount of a halogenated phosphate ester flame retardant such as the FYROL CEF, DE60F, FYROL PCF, and THERMOLIN 101 brand products.

U.S. Pat. No. 5,506,278 describes flame-retardant polyurethane foams comprising melamine and chlorinated phosphate esters such as the THERMOLIN 101 and FYROL CEF brand products.

U.S. Pat. No. 5,885,479 indicates that other flame retardants such as tricresyl phosphate, tris(2-chloroethyl) phosphate, tris(2-chloropropyl) phosphate, tris(1,3-dichloropropyl) phosphate, tris(2,3-dibromopropyl) phosphate and tetrakis(2-chloroethyl) ethylene diphosphate can be used in combination with melamine.

U.S. Pat. No. 4,757,093 discloses the replacement of a certain proportion of the liquid phosphorus ester flame retardant normally employed in polyurethane foams with melamine. Non-halogenated polyphosphate flame retardants are not disclosed in this patent and the examples suggest that the density of the foams that were treated were above 1.5 pounds per cubic foot (lb/ft³), specifically from 1.56 to 1.72 lb/ft³.

PCT Published Patent Application No. WO 03/078497 discloses the use of less than 10 weight percent of both melamine and of one or more additional flame retardants based on the weight of the foam.

The fire retardants used by the flexible slab industry in the United States are primarily intended to meet two flammability tests: the MVSS302 test used by the automotive industry and the California Bureau of Home Furnishings 117A&D test (actually a combination of two tests). This technology is currently dominated by two fire retardant compositions: tris dichloropropyl phosphate or “TDCP” (such as FYROL® FR-2 brand product) and a blend of pentabromodiphenyloxide and a triarylphosphate (such as FYROL® PBR brand product).

### BRIEF SUMMARY OF THE INVENTION

In accordance with the present invention, there is provided a flame retardant composition comprising:

a) a major amount by weight of at least one phosphate ester flame retardant of the formula 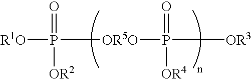
wherein n is 0 or 1 to about 10, R¹, R², R³ and R⁴ each independently is a non-halogenated or halogenated alkyl or aryl group, and R⁵ is a non-halogenated or halogenated alkylene or arylene group, provided, that when n is 1 to about 10, at least one of R¹, R², R³, R⁴ and R⁵ is substituted with at least one halogen atom; and,

b) a minor amount by weight of melamine.

Further in accordance with the invention, the foregoing composition is incorporated in a flame retardant effective amount in a polyurethane foam.

Although many types of polyurethane foam can pass the flammability test employing just the phosphate ester(s), supra, e.g., tris(1,3-dichloropropyl) phosphate, it has been found herein that the use of a major amount of weight of such a phosphate ester(s) in combination with a minor amount by weight of melaamine results in a polyurethane foam with significantly improved smoldering properties in the CAL 117A/D test.

### DETAILED DESCRIPTION OF THE INVENTION

The phosphate ester flame retardants contained in the flame retardant composition are known, e.g., from U.S. Pat. Nos. 5,457,221 and 5,958,993, the entire contents of which are incorporated by reference herein.

In the formula of the phosphate ester flame retardant, supra, R¹, R², R³, R⁴ and R⁵ each independently is preferably a non-halogenated or halogenated alkyl group of from 1 to about 10 carbon atoms, a non-halogenated or halogenated aryl group of from 6 to about 20 carbon atoms or a non-halogenated or halogenated alkyl-substituted aryl group of from 6 to about 20 carbon atoms, and R⁵ is preferably a non-halogenated or halogenated alkylene group of from 2 to about 20 carbon atoms or a non-halogenated or halogenated unsubstituted or lower alkyl-substituted arylene group of from 6 to about 20 carbon atoms. More preferably, each of R¹, R², R³ and R⁴ is independently a non-halogenated or halogenated phenyl group and R⁵ is a non-halogenated or halogenated alkylene group of from 2 to 8 carbon atoms. In the foregoing preferred and more preferred phosphate esters, the halogen is preferably chlorine and n is preferably 0, 1, 2 or 3.

The expression “lower alkyl” shall be understood herein to include alkyl groups containing from 1 to 4 carbon atoms.

Specific examples of monomeric phosphate ester flame retardants for inclusion in the fire retardant composition of this invention include tris(1,3-dichloropropyl) phosphate, tris(2,3-dibromopropyl) phosphate, tris(2-chloroethyl) phosphate, tricresyl phosphate, cresyl diphenyl phosphate, propylated triphenyl phosphate, butylated triphenyl phosphate, and the like.

The flame retardant composition of this invention will contain a major amount by weight of phosphate ester flame retardant(s), preferably from about 55 to about 99.5 weight % phosphate ester(s) and, more preferably, from about 80 to about 99 weight % phosphate ester(s), with the balance being melamine. The phosphate ester(s) and melamine components of the flame retardant composition can be added to the polyurethane-foam forming reaction medium, preferably the monomeric component thereof, either sequentially in any order or as a blend. The amount of combined phosphate ester(s) and melamine can vary widely, e.g., from about 5 to about 50, and preferably from about 10 to about 38, parts by weight per 100 parts by weight of the monomeric component of the polyurethane foam-forming reaction.

The polyurethane foams incorporating the flame retardant composition generally have densities ranging from about 1.0 lb./ft³ to about 2.0 lb./ft³.

In the examples that follow, flame retardant test data were generated using a typical polyether polyurethane flexible foam that was tested at nominal densities of 1.0, 1.5 and 1.8 lb/ft³. The formulations used to make the foams were formed using a polyether polyol having a hydroxyl number of 56, a water level of from 3.55% to 5.6%, an amine level of about 0.25%, and an NCO index of 110. The following standard tests were employed:

A Cal.TB 117 A Test:

This test is a small-scale vertical test with a twelve-second-ignition time. The sample size was 12″×3″×½″. The ignition source was removed after twelve seconds. A second clock is started if the sample continues to bum. The criteria for failing included: a sample exceeding an individual bum of eight inches or average bums of six inches. The time criteria required that an individual specimen would have not an individual afterflame or afterglow exceeding ten seconds or an average afterflame or afterglow exceeding five seconds.

B. Cal.TB 117 D Test:

This test is a smoldering test in which a cigarette is used as the ignition source under a cotton cloth cover. The foam sample was covered with a standard velvet cotton cloth and was placed in s small wooden frame to form a mock chair. The back of the sample was 8″×7″×2″ and the seat was 8″×4″×2″. The sample was preweighted before testing and was again weighed after the test was finished. If the foam lost more than 20% of its weight, it was judged to be a failure.

Tri(1-3-dichloroisopropyl) phosphate (Fyrol FR-2) and a butylated triphenyl phosphate were used in the Cal. TB-117 test in several foams, either alone or in combination with melamine, as further described below.

Since the Cal. TB 117 Test requires passing two very different tests (Parts A and D), the effect of each flame retardant package on each test must be considered. For example, at low densities, it is easier to pass the smoldering test (Part D) and at higher density it is easier to pass the flaming test (Part A).

A. Polyurethane Foam-Forming Procedure

The polyol, flame-retardant(s), water, amine catalyst and silicone surfactant were mixed, with stirring, in a first beaker. In a separate beaker, the toluene diisocyanate (TDI) was weighed out. The organo-tin catalyst was placed in a syringe. The first beaker was stirred at 2100 revolutions per minute for a period of ten seconds and the organo-tin catalyst was then dosed thereto while stirring was continued. After a total of about twenty seconds of stirring, the TDI was added to the mixture. Stirring was then continued for about an additional ten seconds, the still-fluid mixture was quickly put into a 16 inch×16 inch×5 inch box, and then the cream and rise time were measured. Once the foam ceased to rise, the foam was placed in an oven at 70° C. for 20 minutes to cure.

The following data illustrates that relative performance of flame retardant additives varies with foam densities as well as test method and that the described blends resulted in unexpected synergism in some of these combinations. (As density increases, less flame retardant additive is usually required to meet a specific test).

TABLE 1
Fyrol FR-2/Melamine-Cal 117 1.0 pcf

| | Sample | | | |
|---|---|---|---|---|
| | 1 | 2 | 3 | 4 |
| Polyol 1040 (Bayer) | 100.0 | 100.0 | 100.0 | 100.0 |
| tri(1,3-dichloroisopropyl) | 16 | 14 | 14 | 14 |
| phosphate | | | | |
| dichloromethane | 10.0 | 10.0 | 10.0 | 10.0 |
| melamine | 0 | 0 | 0.50 | 0.25 |
| water | 5.6 | 5.6 | 5.6 | 5.6 |
| Dabco ®-33LV/Niax ® A-1 = 3.1 | 0.25 | 0.25 | 0.25 | 0.25 |
| Ratio (OSI) | | | | |
| Silicone Surfactant L-620 (OSI) | 1.0 | 1.0 | 1.0 | 1.0 |
| Stannous Octoate T-10 | 0.35 | 0.35 | 0.35 | 0.35 |
| (Air Products) | | | | |
| toluene diisocyanate (Bayer) | 71.0 | 71.0 | 71.0 | 71.0 |
| TDI Index | 110 | 110 | 110 | 110 |
| Cream time (seconds) | 8 | 8 | 8 | 8 |
| Rise time (seconds) | 103 | 100 | 95 | 95 |
| Air Flow (cfm) | 5.5 | 5.6 | 5.8 | 5.7 |
| Density (lb/ft³) | 1.01 | 1.01 | 1.03 | 1.00 |
| CAL 117 Initial/Dry Heat Test | 3.5″ | 4.2″ | 4.0″ | 5.0″ |
| | 3.8″ | 5.7″ | 4.5″ | 5.6″ |
| CAL 117/D-Smolder Test | 94% | 93% | 98% | 95% |
| | Passed | Failed | Passed | Failed |

TABLE 2
Fyrol FR-2/Melamine-Cal 117 1.8 pcf

| Sample | 5 | 6 | 7 | 8 | 9 | 10 |
|---|---|---|---|---|---|---|
| Polyol 1042 (Dow) | 100.0 | 100.0 | 100.0 | 100.0 | 100.0 | 100.0 |
| tri(1,3-dichloroisopropyl)phosphate | 12 | 10 | 10 | 8 | 7 | 7 |
| dichloromethane | 0 | 0 | 0 | 0 | 0 | 0 |
| melamine | 0 | 0 | 2.0 | 1.0 | 0.50 | 0.25 |
| water | 3.55 | 3.55 | 3.55 | 3.55 | 3.55 | 3.55 |
| Dabco ®-33LV/Niax ® A-1 = 3.1 Ratio(OSI) | 0.23 | 0.23 | 0.23 | 0.23 | 0.23 | 0.23 |
| Silicone Surfactant L-620 (OSI) | 0.80 | 0.80 | 0.80 | 0.80 | 0.80 | 0.80 |
| Stannous Octoate T-10 (Air Products) | 0.35 | 0.35 | 0.35 | 0.35 | 0.35 | 0.35 |
| toluene diisocyanate-TDI (Bayer) | 47.3 | 47.3 | 47.3 | 47.3 | 47.3 | 47.3 |
| TDI Index | 110 | 110 | 110 | 110 | 110 | 110 |
| Cream time (seconds) | 8 | 8 | 8 | 8 | 8 | 8 |
| Rise time (seconds) | 95 | 94 | 93 | 95 | 95 | 92 |
| Air Flow(cfm) | 4.7 | 4.7 | 4.5 | 4.5 | 4.5 | 4.4 |
| Density (lb/ft³) | 1.79 | 1.81 | 1.80 | 1.82 | 1.81 | 1.82 |
| CAL 117 Initial/Dry Heat Test | 3.8″ | 4.5″ | 3.2″ | 3.4″ | 4.1″ | 4.6″ |
| | 3.3″ | Failed | 3.4″ | 3.9″ | 4.4″ | 5.1″ |
| CAL 117/D-Smolder Test | 82% | 78% | 88% | 88% | 85% | 84% |
| | | Failed | | | | Failed |

TABLE 3
Butylated diphenyl phosphate/Melamine-Cal 117 1.0 pcf

| | Sample | | |
|---|---|---|---|
| | 11 | 12 | 13 |
| Polyol 1040 (Bayer) | 100.0 | 100.0 | 100.0 |
| butylated triphenyl phosphate | 20 | 16 | 18 |
| dichloromethane | 10.0 | 10.0 | 10.0 |
| melamine | 0 | 0 | 5.0 |
| water | 5.6 | 5.6 | 5.6 |
| Dabco ®-33LV/Niax ® A-1 = 3.1 | 0.25 | 0.25 | 0.25 |
| Ratio (OSI) | | | |
| Silicone Surfactant L-620 (OSI) | 1.0 | 1.0 | 1.0 |
| Stannous Octoate T-10 (Air Products) | 0.55 | 0.35 | 0.35 |
| toluene diisocyanate-TDI (Bayer) | 71.0 | 71.0 | 71.0 |
| TDI Index | 110 | 110 | 110 |
| Cream time (seconds) | 8 | 8 | 8 |
| Rise time (seconds) | 101 | 108 | 108 |
| Air Flow (cfm) | 4.1 | 4.4 | 4.2 |
| Density (lb/ft³) | 1.01 | 1.03 | 1.04 |
| CAL 117 Initial/Dry Heat Test | 4.5″ | Failed | 4.5″ |
| | 5.5″ | | 4.9″ |
| CAL 117/D-Smolder Test | 93% | 95% | 97% |

TABLE 4
Butylated triphenyl phosphate/Melamine-Cal 117 1.5 pcf

| | Sample | | |
|---|---|---|---|
| | 14 | 15 | 16 |
| Polyol 1040 (Bayer) | 100.0 | 100.0 | 100.0 |
| butylated triphenyl phosphate | 17 | 15 | 15 |
| dichloromethane | 2.0 | 2.0 | 2.0 |
| melamine | 0 | 0 | 5.0 |
| water | 3.85 | 3.85 | 3.85 |
| Dabco ®-33LV/Niax ® A-1 = 3.1 | 0.24 | 0.24 | 0.24 |
| Ratio (OSI) | | | |
| Silicone Surfactant L-620 (OSI) | 0.8 | 0.8 | 0.8 |
| Stannous Octoate T-10 (Air Products) | 0.40 | 0.40 | 0.40 |
| toluene diisocyanate-TDI (Bayer) | 51.06 | 51.06 | 51.06 |
| TDI Index | 110 | 110 | 110 |
| Cream time (seconds) | 8 | 7 | 8 |
| Rise time (seconds) | 107 | 108 | 106 |
| Air Flow (cfm) | 4.5 | 4.5 | 4.1 |
| Density (lb/ft³) | 1.49 | 1.49 | 1.52 |
| CAL 117 Initial/Dry Heat Test | 5.2″ | 5.8″ | 5.1″ |
| | 5.5″ | 5.7″ | 5.3″ |
| CAL 117/D-Smolder Test | 88% | 86% | 97% |

TABLE 5
Butylated triphenyl phosphate/Melamine-Cal 117 1.8 pcf

| | Sample | | |
|---|---|---|---|
| | 17 | 18 | 19 |
| Polyol 1040 (Bayer) | 100.0 | 100.0 | 100.0 |
| butylated triphenyl phosphate | 15 | 14 | 8 |
| dichloromethane | 0 | 0 | 0 |
| melamine | 0 | 0 | 5.0 |
| water | 3.55 | 3.55 | 3.55 |
| Dabco ®-33LV/Niax ® A-1 = 3.1 | 0.23 | 0.23 | 0.23 |
| Ratio (OSI) | | | |
| Silicone Surfactant L-620 (OSI) | 0.8 | 0.8 | 0.8 |
| Stannous Octoate T-10 (Air Products) | 0.30 | 0.30 | 0.30 |
| toluene diisocyanate-TDI (Bayer) | 47.30 | 47.30 | 47.30 |
| TDI Index | 110 | 110 | 110 |
| Cream time (seconds) | 8 | 8 | 8 |
| Rise time (seconds) | 114 | 115 | 115 |
| Air Flow (cfm) | 4.7 | 4.6 | 4.6 |
| Density (lb/ft³) | 1.81 | 1.82 | 1.82 |
| CAL 117 Initial/Dry Heat Test | 5.5″ | Failed | 5.1″ |
| | 5.7″ | | 5.3″ |
| CAL 117/D-Smolder Test | 86% | 84% | 97% |

From an analysis of the data for the CAL 117 A/D several conclusions can be reached:

There is an advantage in using the combination of flame retardant (Fyrol FR-2 or butylated triphenyl phosphate) and melamine in all densities. At the 1 lb/ft³ density, the presence of a small amount of melamine helps the flaming performance (Examples 2, 3 and 13) whereas at 1.8 lb/ft³ density, the smoldering performance is greatly enhanced by the addition of small amount of melamine (Examples 7, 8, 9 and 18). Smoldering improvement is also observed with the 1.5 lb./ft³ with the addition of melamine (Example 16).

The foregoing examples merely illustrate certain embodiments of the present invention and, for that reason should not be construed in a limiting sense. The scope of protection that is sought is set forth in the claims that follow.

1. A flame retardant composition which comprises:
a) a major amount by weight of at least one phosphate ester flame retardant of the formula: 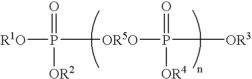
wherein n is 0 or 1 to about 10, R¹, R², R³ and R⁴ each independently is a non-halogenated or halogenated alkyl or aryl group, and R⁵ is a non-halogenated or halogenated alkylene or arylene group, provided, that when n is 1 to about 10, at least one of R¹, R², R³, R⁴ and R⁵ is substituted with at least one halogen atom; and,
b) a minor amount by weight of melamine.

2. The flame retardant composition of claim 1 wherein each of R¹, R², R³, R⁴ and R⁵ is independently a non-halogenated or halogenated alkyl group of from 1 to about 10 carbon atoms, a non-halogenated or halogenated aryl group of from 6 to about 20 carbon atoms or a non-halogenated or halogenated alkyl-substituted aryl group of from 6 to about 20 carbon atoms, and R⁵ is a non-halogenated or halogenated alkylene group of from 2 to about 20 carbon atoms or a non-halogenated or halogenated unsubstituted or lower alkyl-substituted arylene group of from 6 to about 20 carbon atoms.

3. The flame retardant composition of claim 2 wherein each of R¹, R², R³ and R⁴ is independently a non-halogenated or halogenated phenyl group and R⁵ is a non-halogenated or halogenated alkylene group of from 2 to 8 carbon atoms.

4. The flame retardant composition of claim 2 wherein in a halogenated group, the halogen is chlorine and n is 0, 1, 2 or 3.

5. The flame retardant composition of claim 3 wherein in a halogenated group, the halogen is chlorine and n is 0, 1, 2 or 3.

6. The flame retardant composition of claim 1 wherein the phosphate ester is at least one member of the group consisting of each independently is tris(1,3-dichloropropyl) phosphate, tris(2,3-dibromopropyl) phosphate, tris(2-chloroethyl) phosphate, tricresyl phosphate, cresyl diphenyl phosphate, propylated triphenyl phosphate, butylated triphenyl phosphate and combinations thereof.

7. The flame retardant composition of claim 1 containing from about 55 to about 99.5 weight % phosphate ester, the balance of the composition being melamine.

8. The flame retardant composition of claim 1 containing from about 80 to 99 weight % phosphate ester, the balance of the composition being melamine.

9. A flame retardant polyurethane foam composition comprising a flame retarding amount of the flame retardant composition of claim 1.

10. A flame retarded polyurethane foam composition comprising a flame retarding amount of the flame retardant composition of claim 2.

11. A flame retarded polyurethane foam composition comprising a flame retarding amount of the flame retardant composition of claim 3.

12. A flame retarded polyurethane foam composition comprising a flame retarding amount of flame retardant composition of claim 4.

13. A flame retarded polyurethane foam composition comprising a flame retarding amount of the flame retardant composition of claim 5.

14. A flame retarded polyurethane foam composition comprising a flame retarding amount of the flame retardant composition of claim 6.

15. The flame retarded polyurethane foam composition of claim 9 wherein the polyurethane foam possesses a density of 1.0 to 2.0 lb/ft³.

16. A method of making a flame retarded polyurethane foam which comprises adding a flame retarding amount of flame retardant composition of claim 1 to a polyurethane foam-forming reaction medium comprising polyol and polyisocyanate and causing the polyurethane foam-forming reaction medium to undergo reaction to provide polyurethane foam containing the flame retardant composition.

17. The method of claim 16 wherein the phosphate ester and melamine components of the flame retardant composition are added to the polyurethane foam-forming reaction medium as a blend.

18. The method of claim 17 wherein the blend is added to the polyol-containing component of the polyurethane foam-forming reaction medium.

19. The method of claim 16 wherein in the phosphate ester, each of R¹, R², R³, and R⁴ is a phenyl group.

20. The method of claim 16 wherein the phosphate ester is at least one member of the group consisting of each independently is tris(1,3-dichloropropyl) phosphate, tris(2,3-dibromopropyl) phosphate, tris(2-chloroethyl) phosphate, tricresyl phosphate, cresyl diphenyl phosphate and combinations thereof.

21. The method of claim 16 containing from about 55 to about 99.5 weight % phosphate ester, the balance of the composition being melamine.

22. The method of claim 16 containing from about 80 to about 99 weight % phosphate ester, the balance of the composition being melamine.

23. The method of claim 17 wherein from about 5 to about 50 parts by weight of the blend are added per 100 parts by weight of the polyol-containing component of the polyurethane foam-forming reaction medium.

24. The method of claim 17 wherein from about 10 to about 30 parts by weight of the blend are added per 100 parts by weight of the polyol-containing component of the polyurethane foam-forming reaction medium.

25. The method of claim 18 wherein from about 5 to about 50 parts by weight of the blend are added per 100 parts by weight of the polyol-containing component of the polyurethane foam-forming reaction medium.

26. The method of claim 18 wherein from about 10 to about 30 parts by weight of the blend are added per 100 parts by weight of the polyol-containing component of the polyurethane foam-forming reaction medium.

27. The method of claim 16 wherein the polyurethane foam possesses a density below about 1.5 lb/ft³.

28. The method of claim 16 wherein the polyurethane foam possesses a density below about 1.2 lb/ft³.
